(19) United States
(12) Patent Application Publication
(10) Pub. No.: US 2013/0305807 A1
(43) Pub. Date: Nov. 21, 2013

(54) GAS DETECTOR TEST SYSTEM AND APPARATUS

(71) Applicants: SHIH-CHENG WANG, Tu-Cheng (TW); YI-WEN CAI, Tu-Cheng (TW)

(72) Inventors: SHIH-CHENG WANG, Tu-Cheng (TW); YI-WEN CAI, Tu-Cheng (TW)

(73) Assignee: HON HAI PRECISION INDUSTRY CO., LTD., Tu-Cheng (TW)

(21) Appl. No.: 13/472,653

(22) Filed: May 16, 2012

(51) Int. Cl. G01N 1/00

(52) U.S. Cl. 73/23.2

(57) ABSTRACT

A gas detector test system is provided. The gas detector test system includes a test apparatus and a control apparatus. The test apparatus includes a housing, a baffle, an elastic device, a gas discharger, and a gas sensor. The housing defines an inner space communicating with an opening. The elastic device pushes the baffle disposed in the inner space toward the opening, thereby sealing the opening. The baffle can be moved against the opening to form an interval between the baffle and the opening. The gas sensor produces a gas parameter signal according to a gas detected in the inner space. The control apparatus controls the gas discharger of the test apparatus to discharge gas according to a control signal, and displays the information of the gas according to the gas parameter signal. The disclosure further provides a gas detector test apparatus.

### BACKGROUND

1. Technical Field

The present disclosure relates to a gas detector test system and a gas detector test apparatus, and particularly to a gas detector test system and a gas detector test apparatus for a gas detector.

2. Description of Related Art

Testing methods of gas detectors such as a toxic gas detector, include using a spray to provide a gas for testing the gas detector. The gas detector can be enabled when the density of the gas is over a pre-set amount. However, the density of the gas is usually difficult to manually control. Hence, the gas detector often cannot be successfully enabled, and the gas is wasted if the density of the gas is inadequate for the gas detector.

What is needed, therefore, is a gas detector test system capable of overcoming the limitations described.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a gas detector test system of the present disclosure.

FIG. 2 is a schematic diagram of an embodiment of the test apparatus shown in FIG. 1.

FIG. 3 is a schematic diagram of using the gas detector test system shown in FIG. 2.

### DETAILED DESCRIPTION

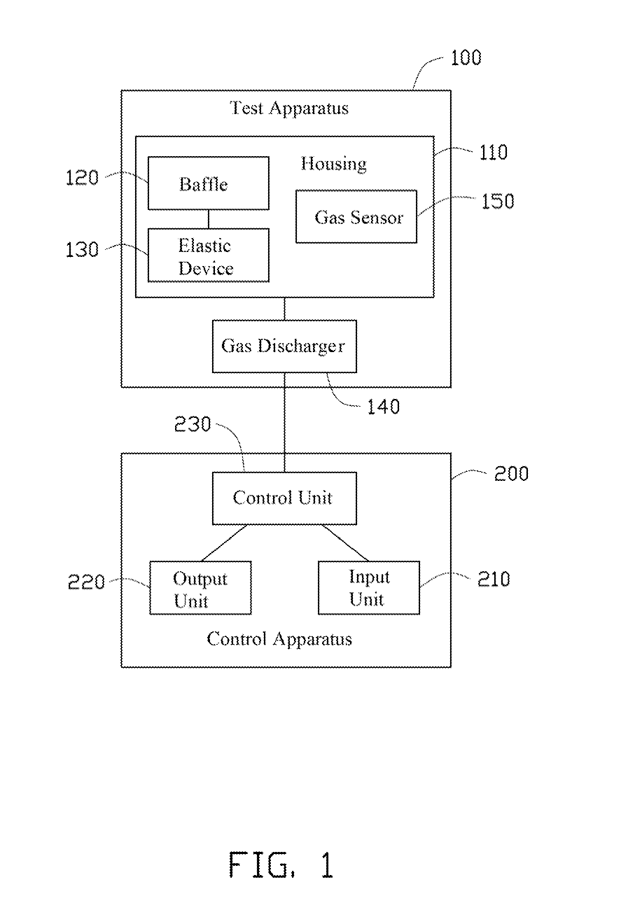

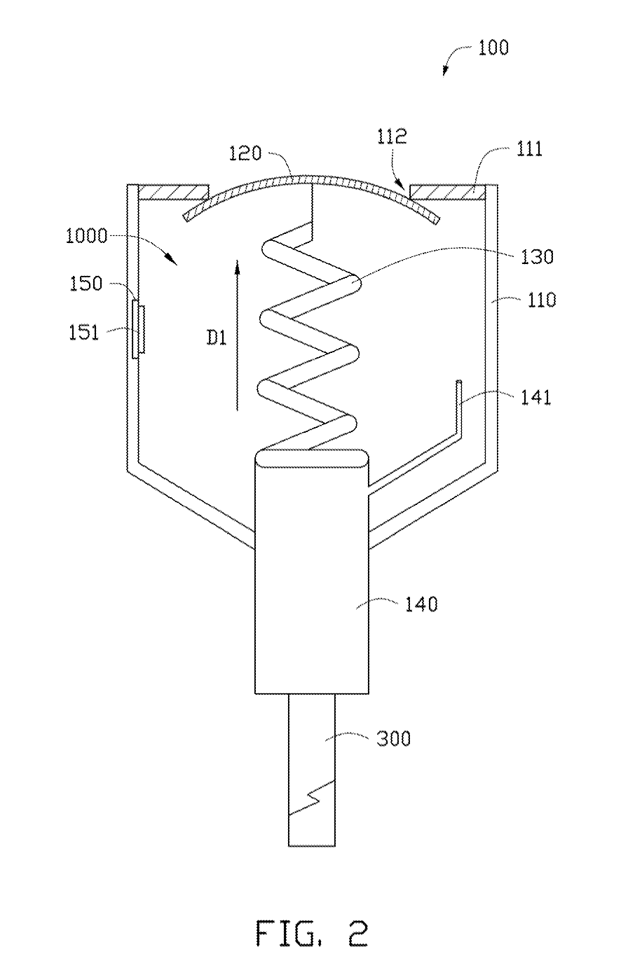

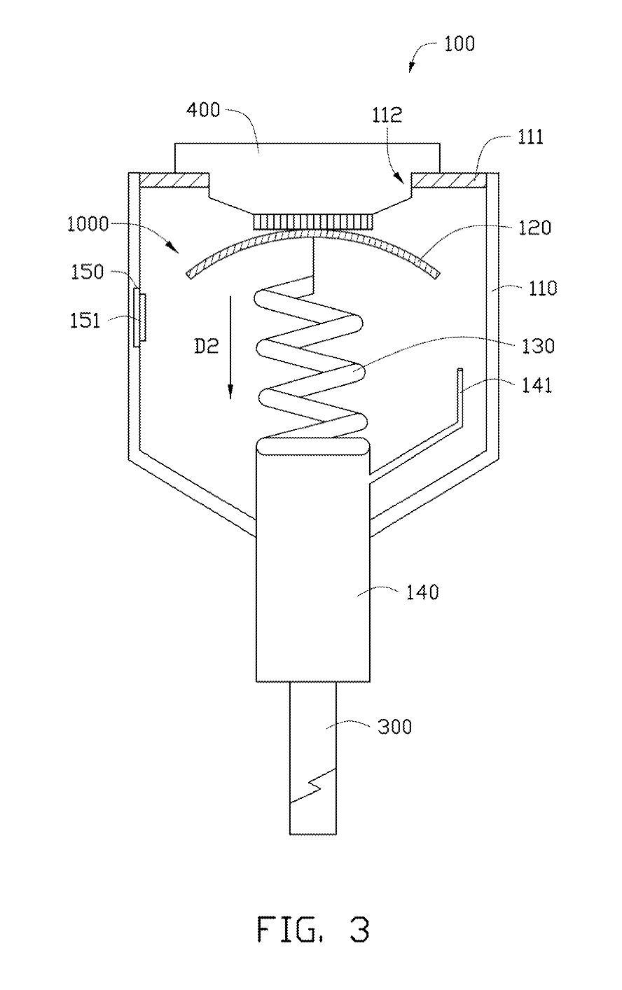

FIG. 1 is a block diagram of an embodiment of a gas detector test system of the present disclosure. The gas detector test system includes a test apparatus 100 and a control apparatus 200. FIG. 2 is a schematic diagram of an embodiment of the test apparatus 100 shown in FIG. 1. The test apparatus 100 includes a housing 110, a baffle 120, an elastic device 130, a gas discharger 140, and a gas sensor 150. The housing 110 includes a top wall 111. An opening 112 is formed at a central portion of the top wall 111. In the illustrated embodiment, the top wall 111 is a resilient pad made of, for example, rubber or sponge. The opening 112 has a circular shape. In other embodiments, the top wall 111 can be other types of material which has the resilience to facilitate the baffle 120 to seal the opening 112, and to facilitate an object inserted into the opening 112 to closely face the top wall 111 (see FIG. 3). The opening 112 can have other shapes such as a square shape to accommodate an object inserted into the opening 112. The housing 110 defines an inner space 1000 which communicates with the opening 112. Gases in the inner space 1000 and the exterior space outside the opening 112 can convect through the opening 112.

The baffle 120 is movably disposed in the inner space 1000. The elastic device 130 pushes the baffle 120 in a first direction Dl toward the opening 112, thereby sealing the opening 112. The elastic device 130 seals the opening 112 by engaging the baffle 120 with a rim of the top wall 111 around the opening 112. In the illustrated embodiment, the baffle 120 is bowl-shaped. The elastic device 130 is a spring connected to a concave portion of the baffle 120, for example, a coil spring or a gas spring, which enables a convex portion of the baffle 120 to touch the top wall 111. In other embodiments, the baffle 120 can have another shape such as flat shape. The elastic device 130 can be another type of component which is capable of storing mechanical energy for pushing the baffle 120.

The gas discharger 140 includes a nozzle 141. The gas discharger 140 discharges a gas into the inner space 1000 through the nozzle 141. When the baffle 120 seals the opening 112, the gases in the inner space 1000 including the gas discharged by the gas discharger 140 are sealed up in the inner space 1000. In the illustrated embodiment, the gas sensor 150 has a sensing portion 151 in the inner space 1000 to detect gas in the inner space 1000. The gas sensor 150 produces a gas parameter signal Sg (not shown) in response to detecting the gas in the inner space 1000. The gas parameter signal Sg includes an actual gas density information. In other embodiments, the entire gas sensor 150 can be disposed in the inner space 1000. The gas parameter signal Sg can include, for example, the type of the gas.

The control apparatus 200 includes an input unit 210, an output unit 220, and a control unit 230. The control apparatus 200 is connected to the test apparatus 100 through a pole 300 which is adjustable in length. In the illustrated embodiment, the input unit 210 is a keyboard, and the output unit 220 is a display. In other embodiments, the input unit 210 and the output unit 220 can be other types of devices, for instance, the input unit 210 and the output unit 220 together can be a single device such as a touch panel. The control unit 230 controls the gas discharger 140 of the test apparatus 100 to discharge the gas according to a control signal Sc (not shown) received from the input unit 210 and the gas parameter signal Sg received from the gas sensor 150. In the illustrated embodiment, the control signal Sc includes a required gas density information. The control unit 230 determines whether the density of the gas in the inner space 1000 represented by the actual gas density information in the gas parameter signal Sg meets a requirement represented by the required gas density information in the control signal Sc. If no, the control unit 230 controls the gas discharger 140 to continuously discharge the gas into the inner space 1000; if yes, the control unit 230 controls the gas discharger 140 to stop discharging the gas. In other embodiments, the control signal Sc can include, for example, the type of the gas to be discharged. The control unit 230 further controls the output unit 220 to display information according to the gas parameter signal Sg received from the gas sensor 150. For instance, the density of the gas in the inner space 1000 can be displayed through the output unit 220 according to the actual gas density information in the gas parameter signal Sg.

FIG. 3 is a schematic diagram of using the gas detector test system shown in FIG. 2. The baffle 120 of the test apparatus 100 can be moved in a second direction D2 against the opening 112 to form an interval between the baffle 120 and the opening 112, thereby allowing the gas in the inner space 1000 to enter a device under test (DUT) 400, for example, a gas detector inserted into the opening 112, through the interval. In the illustrated embodiment, the second direction D2 is opposite to the first direction D1. In other embodiments, the angle between the second direction D2 and the first direction D1 can be other than 180 degrees. When the DUT 400 is removed, the baffle 120 is restored to the original place shown in FIG. 2 through the elastic device 130.

The gas detector test system is capable of providing a gas of certain density to a gas detector under test in an automatic manner. Hence, the amount of the gas provided to the gas detector can easily be controlled. Consequently, the gas detector can always be successfully enabled while the waste of the gas is reduced.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A gas detector test system, comprising:
a test apparatus comprising:
a housing comprising an opening, wherein the housing defines an inner space communicating with the opening;
a baffle movably disposed in the inner space;
an elastic device pushing the baffle in a first direction toward the opening to substantially seal the opening, wherein the baffle is selectively moved in a second direction against the opening to form an interval between the baffle and the opening;
a gas discharger discharging a gas into the inner space; and
a gas sensor producing a gas parameter signal according to the gas detected in the inner space; and
a control apparatus comprising:
an input unit;
an output unit; and
a control unit, wherein the control unit controls the gas discharger of the test apparatus to discharge gas according to a control signal from the input unit and the gas parameter signal from the gas sensor, and controls the output unit to display information according to the gas parameter signal received from the gas sensor.

2. The gas detector test system of claim 1, wherein the housing comprises a top wall comprising the opening, the elastic device seals the opening by engaging the baffle with a rim of the top wall around the opening.

3. The gas detector test system of claim 2, wherein the top wall comprises a resilient pad, the resilient pad comprises the opening formed at a central portion of the resilient pad.

4. The gas detector test system of claim 1, wherein a sensing portion of the gas sensor is in the inner space.

5. The gas detector test system of claim 1, further comprising a pole connected between the test apparatus and the control apparatus.

6. A gas detector test apparatus comprising:
a housing comprising an opening, wherein the housing defines an inner space communicating with the opening;
a baffle movably disposed in the inner space;
an elastic device pushing the baffle in a first direction toward the opening to substantially seal the opening, wherein the baffle is selectively moved in a second direction against the opening to form an interval between the baffle and the opening;
a gas discharger selectively discharging a gas into the inner space; and
a gas sensor producing a gas parameter signal according to the gas detected in the inner space.

7. The gas detector test apparatus of claim 6, wherein the housing comprises a top wall comprising the opening, the elastic device seals the opening by engaging the baffle with a rim of the top wall around the opening.

8. The gas detector test apparatus of claim 7, wherein the top wall comprises a resilient pad, the resilient pad comprises the opening formed at a central portion of the resilient pad.

9. The gas detector test apparatus of claim 6, wherein a sensing portion of the gas sensor is in the inner space.

10. The gas detector test apparatus of claim 6, wherein the elastic device comprises a spring.
